(19) United States
(12) Patent Application Publication
(10) Pub. No.: US 2008/0019818 A1
(43) Pub. Date: Jan. 24, 2008

(54) Stacking apparatus for comestible portions on carrier sheets and method for stacking

(76) Inventors: David Kent, West Chester, PA (US); Jonathan C. Kent, Coatesville, PA (US)

Correspondence Address: Laurence A. Weinberger, 429 Exton Commons, Exton, PA, 19341, US

(21) Appl. No.: 11/714,090

(22) Filed: Mar. 5, 2007

Related U.S. Application Data
(60) Provisional application No. 60/778,984, filed on Mar. 3, 2006.

(51) Int. Cl. B65G 57/03

(52) U.S. Cl. 414/788.1; 414/802

(57) ABSTRACT

An apparatus and method for uniformly and rapidly stacking one or more comestible portions provided on carrier sheets is described. Such carrier sheets are often used as a separator sheet after stacking. In the apparatus of the invention, linear slide platform fingers intermesh with an o-ring acceleration conveyor. The comestible portion and carrier sheet are delivered onto the intermeshed fingers while constantly being driven forward by the acceleration conveyor. As the linear slide pulls the fingers away from the acceleration conveyor, it accelerates rapidly and causes the comestible portion and carrier sheet to engage separator bars which cause the comestible portion and carrier sheet to fall into a uniform stack.

The benefit of U.S. Provisional Application No. 60/778,984 filed on Mar. 3, 2006 is hereby claimed for this application.

### FIELD OF INVENTION

The present invention relates to an automatic stacking system for the stacking of multiple comestible portions distributed on carrier sheets

### BACKGROUND OF THE INVENTION

In the food industry, a great many food products are portioned into one or more units and placed on a carrier sheets and then stacked one on top of the other prior to placing into a final container for sale. To facilitate the removal of individual portions (one or more items) the portioned comestible portions are packaged so that individual portions are separated by the carrier sheets for easy access further keeping comestible portions from sticking together.

The major drawback to the current system and method of stacking portioned comestible portions on the carrier sheets is that it is highly labor intensive. Several other inventions have tried to automate the stacking of portioned comestible portions on carrier sheets with limited or no success. Many failures include: 1) the inability of maintaining the portioned arrangement on the carrier sheets; 2) the comestible portion sliding off the carrier sheets when stacking; and 3) the difficulty in creating uniform stacks of products on carrier sheets at higher stacking rates of up to 100 or more portions per minute. In addition, the automatic stacking apparatus and method of the present invention eliminates the problem of repetitive motion syndrome associated with manual labor. The apparatus and method of this invention also provides an efficient method of producing uniform stacks of portioned comestible products on carrier sheets, while maintaining both the arrangement and placement of each portion.

### BRIEF DESCRIPTION OF THE DRAWINGS

FIG. 1 is a side elevation view of an automatic stacking system in accordance with the invention with the horizontal linear slide rack fingers intermeshed with the acceleration conveyor 0-ring belts.

FIG. 2 is a top elevation view of the automatic stacking system of FIG. 1 showing the horizontal linear slide rack fingers intermeshed with the acceleration conveyor 0-ring belts.

FIG. 3 is a side elevation view of the automatic stacking system showing a comestible portion on carrier sheet advancing onto the horizontal linear slide rack fingers extended between the acceleration conveyor belts of FIG. 1.

FIG. 3A is a front elevation view along A-A′ of FIG. 3 of the separator showing the horizontal linear slide rack fingers extending forward outward between the stationary vertical separator bars.

FIG. 4 is a side elevation view of the automatic stacking system at a slightly later time than displayed in FIG. 3 showing a comestible portion on carrier sheet advancing sufficiently further onto the horizontal linear slide rack fingers so as to engage the stop bars on the fingers.

FIG. 5 is a side elevation view of the automatic stacking system at a slightly later time than displayed in FIG. 4 showing a comestible portion on carrier sheet completely supported by the horizontal linear slide rack fingers which have been partially retracted.

FIG. 6 is a side elevation view of the automatic stacking system at a slightly later time than displayed in FIG. 5 showing the horizontal linear slide rack fully retracted and the comestible portion on carrier sheet in the process of falling down to form another stack layer.

FIG. 7 is a side elevation view of the automatic stacking system at a slightly later time than displayed in FIG. 6 showing the horizontal linear slide rack repositioned with its fingers intermeshing with the accelerator conveyor, and the previously handled comestible portion on its carrier sheet now forming the top layer of the stack.

FIG. 8 is a side elevation view of the automatic stacking system with optional second lower horizontal linear slide platform stacker located beneath the first top horizontal linear slide platform with two portions already stacked in an intermediate stack on the lower horizontal linear slide platform stacker.

FIG. 9 is a side elevation view of the automatic stacking system of FIG. 8 showing a comestible portion on carrier sheet advancing onto the top horizontal linear slide rack fingers extended between the acceleration conveyor belts of FIG. 8.

FIG. 10 is a side elevation view of the automatic stacking system of FIG. 8 at a slightly later time than displayed in FIG. 9 showing a comestible portion on carrier sheet advancing sufficiently further onto the top horizontal linear slide rack fingers so as to engage the stop bars on the fingers.

FIG. 11 is a side elevation view of the automatic stacking system of FIG. 8 at a slightly later time than displayed in FIG. 10 showing a comestible portion on carrier sheet completely supported by the top horizontal linear slide rack fingers, which have been partially retracted, thereby bringing the comestible portion on carrier sheet into contact with the separator plate.

FIG. 12 is a side elevation view of the automatic stacking system of FIG. 8 at a slightly later time than displayed in FIG. 11 showing the top horizontal linear slide rack fully retracted and the comestible portion on carrier sheet in the process of falling down to form another stack layer on the lower horizontal linear slide rack fingers.

FIG. 13 is a side elevation view of the automatic stacking system of FIG. 8 at a slightly later time than displayed in FIG. 12 showing the top horizontal linear slide rack repositioned with fingers intermeshed between the belts of the acceleration conveyor and the previously handled comestible portion on carrier sheet forming the top layer of the stack on the lower horizontal linear slide rack fingers.

FIG. 14 is a side elevation view of the automatic stacking system of FIG. 8 at a slightly later time than displayed in FIG. 13 showing a comestible portion on carrier sheet advancing onto the top horizontal linear slide rack and the lower horizontal linear slide rack retracted thereby permitting the intermediate stack to fall onto the lower conveyor which may then move the stacked products on carrier sheets aside.

### DETAILED DESCRIPTION OF THE INVENTION

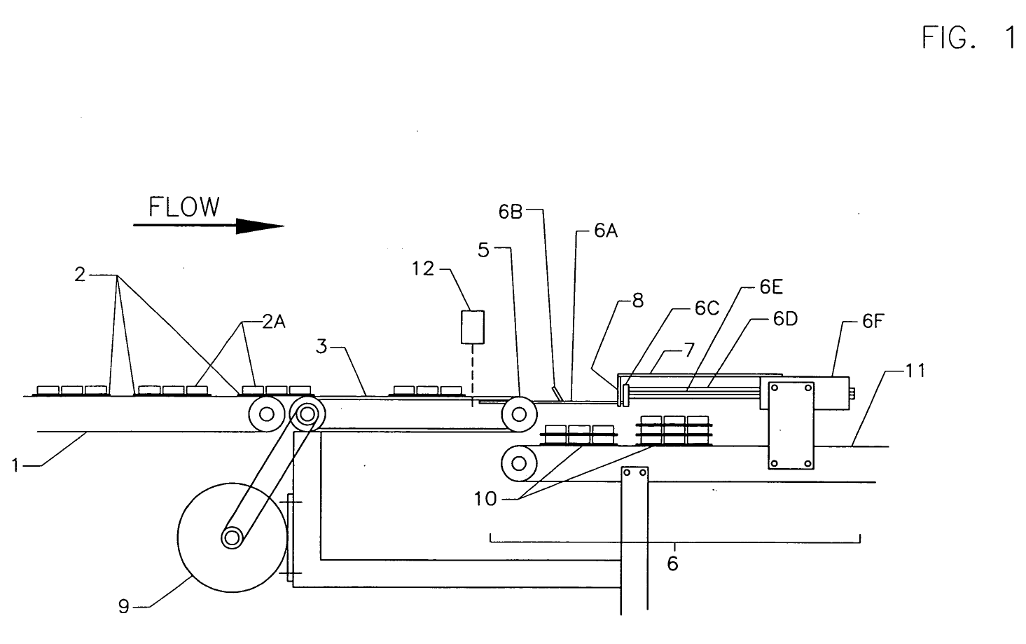

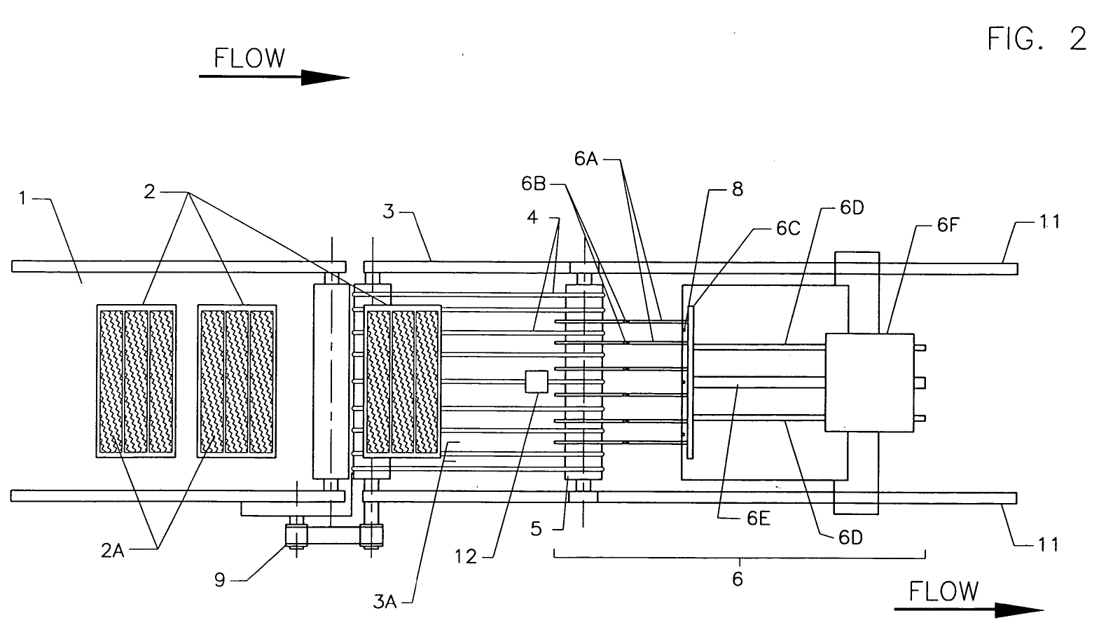

Comestible food portion 2A is dispensed by appropriate means well known in the art onto carrier sheets 2 that are then stacked by the device of this invention. Referring to FIG. 1 and FIG. 2, the automatic stacking system generally comprises an o-ring type acceleration conveyor 3 having spaces 3A between the several separate o-rings/belts 4, a horizontal linear slide platform stacker 6 with protruding fingers 6A and a stack takeaway conveyor 11. The acceleration conveyor 3 is typically supplied with food portions 2A on carrier sheets 2 from an initial conveyor device 1 and conveys product in the same direction as conveyor device 1. The overall movement direction is indicated by heavy arrows. Acceleration conveyor 3 has a linear conveying speed greater than the linear conveying speed of initial conveyor 1. As portions 2A on carrier sheets 2 arrive at and transfer to acceleration conveyor 3, the increased speed of acceleration conveyor 3 creates a larger gap or distance between sequential carrier sheets 2. This larger distance essentially spreads out in time the arrival of carrier sheets 2 at the end of conveyor 3 in order to provide more time for stacking.

The horizontal linear slide platform stacker assembly 6 comprises: a) protruding fingers 6A; b) stops 6B, which are angled toward the unmounted ends of fingers 6A, mounted on fingers 6A; c) a mounting block 6C to which fingers 6A are secured; d) horizontal linear slide support rods 6D; e) a horizontal drive rod 6E; and e) a linear servo motor assembly 6F.

The horizontal linear slide platform stacker mounting block 6C may be advanced by linear servo motor assembly 6F so that fingers 6A pass between and slightly below the top of the separate o-ring belts 4 of acceleration conveyor 3 such that approximately 50% of finger 6A length, as measured from angled stops 6B to the end of fingers 6A, is intermeshed between acceleration conveyor belts 4.

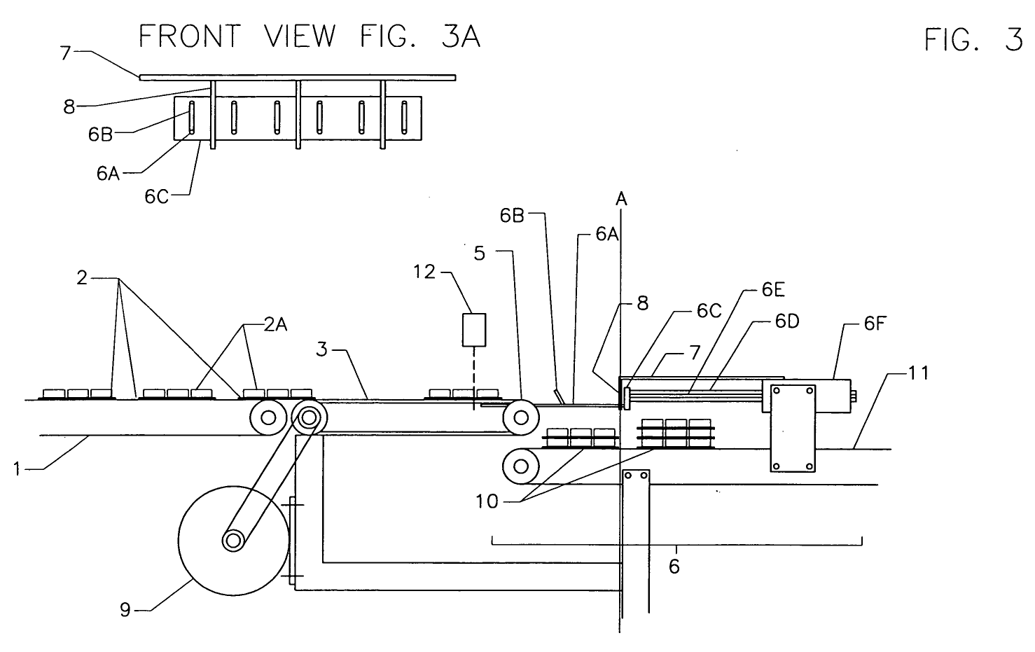

The stacking operation will now be described by reference to FIG. 3 through FIG. 6. After each stacking operation, the horizontal linear slide platform stacker is repositioned as shown in FIG. 2 to await the next carrier sheet. In FIG. 3, as the comestible food portion 2A and carrier sheet 2 moves along acceleration conveyor 3 approaching the end of the conveyor, a photo eye sensor 12 detects the presence of the carrier sheet 2 and activates the linear servo motor assembly 6F. In FIG. 3, as carrier sheet 2 arrives at the end of the acceleration conveyor 3, carrier sheet 2 is transferred to horizontal linear slide platform fingers 6A. The slide platform linear motor assembly 6F starts to retract the slide platform mounting block 6C in a direction away from the end of acceleration conveyor 3 at an initial rate of an equivalent or slightly slower speed than the speed of acceleration conveyor 3. Acceleration conveyor 3 continues to push the comestible portion 2A on carrier sheet 2 onto fingers 6.

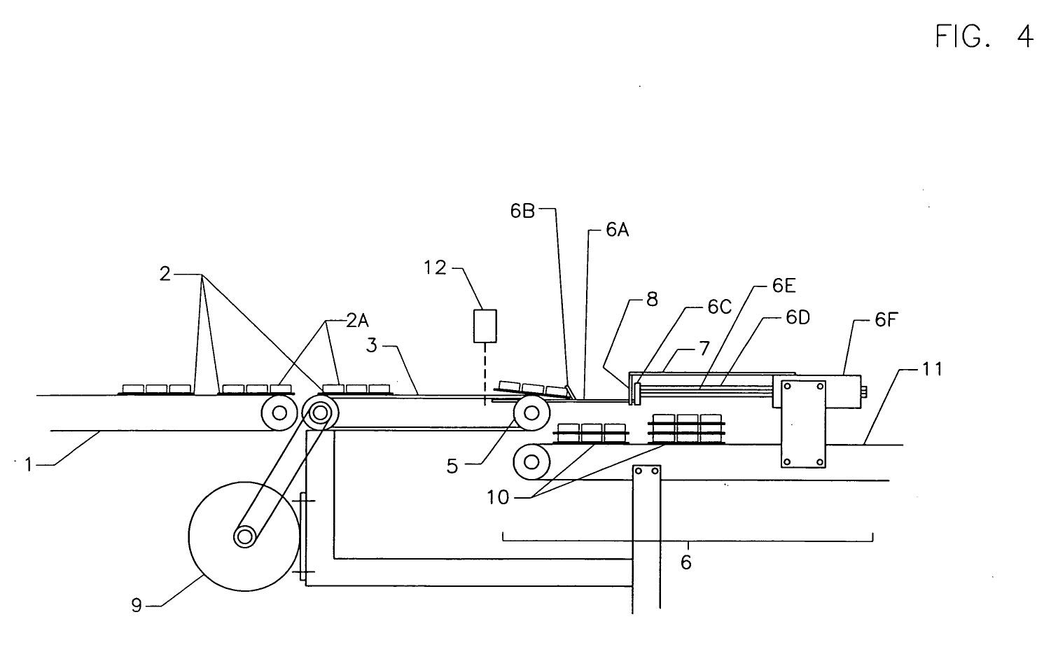

Due to the motion of acceleration conveyor 3, the forward momentum of portion 2A and carrier sheet 2 aids in transferring the portion 2A and carrier sheets 2 onto fingers 6A and further causes carrier sheet 2 to advance on fingers 6A until halted by angled stops 6B as shown in FIG. 4. Angled stops 6B create a reference stop position for stacking by preventing the portion 2A and carrier sheet 2 from sliding off fingers 6A. As the portion 2A on carrier sheet 2 is approaching fingers 6A or being transferred onto fingers 6, the initial rate of retraction by linear servo assembly 6F may be varied based upon the speed of the acceleration conveyor 3 which may be monitored by a conveyor speed sensor built into motor 9.

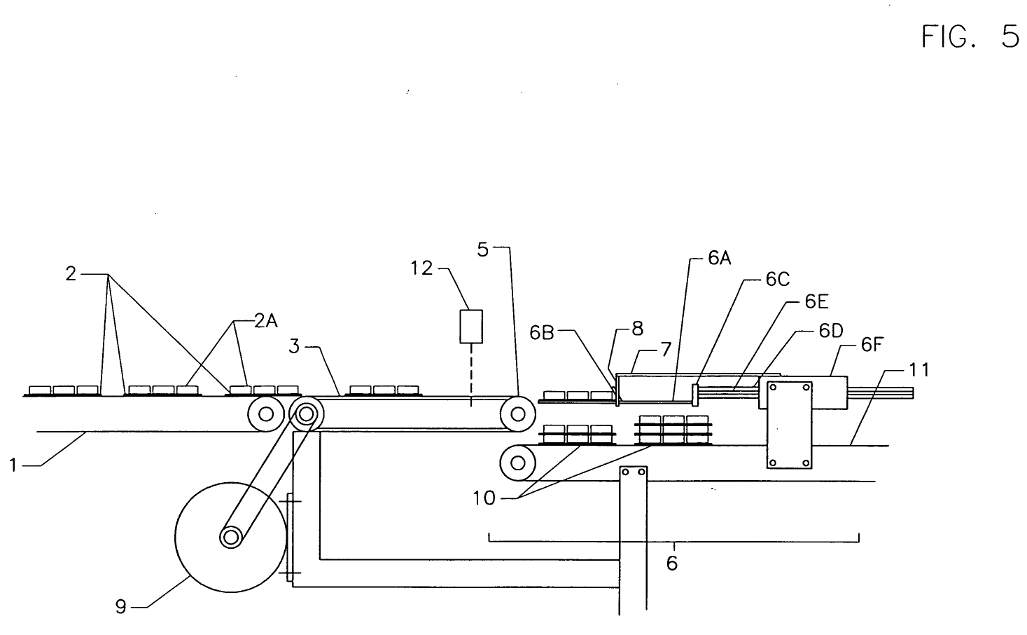

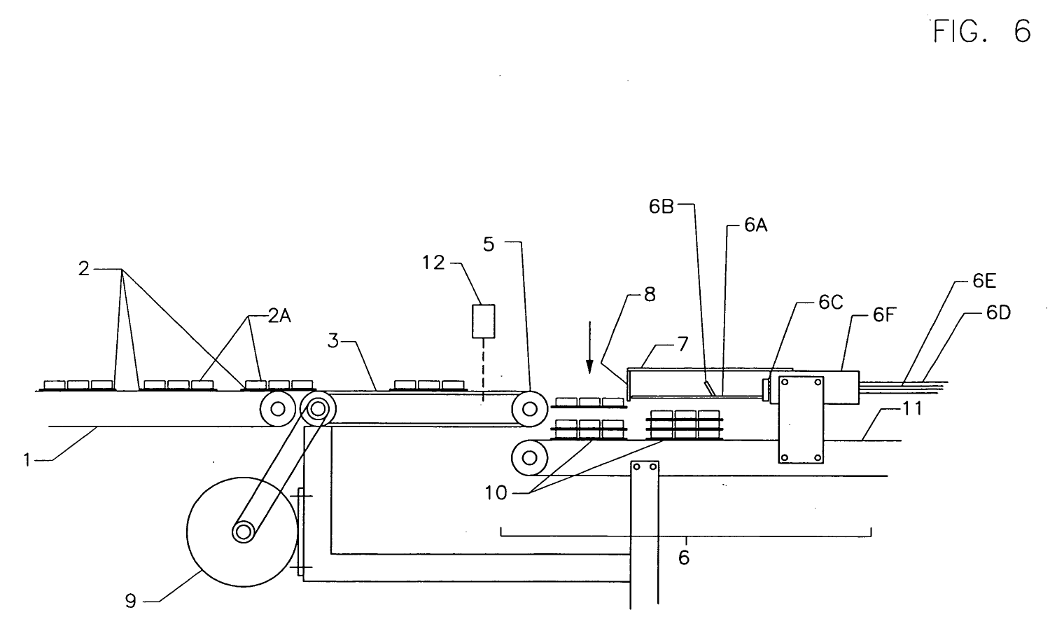

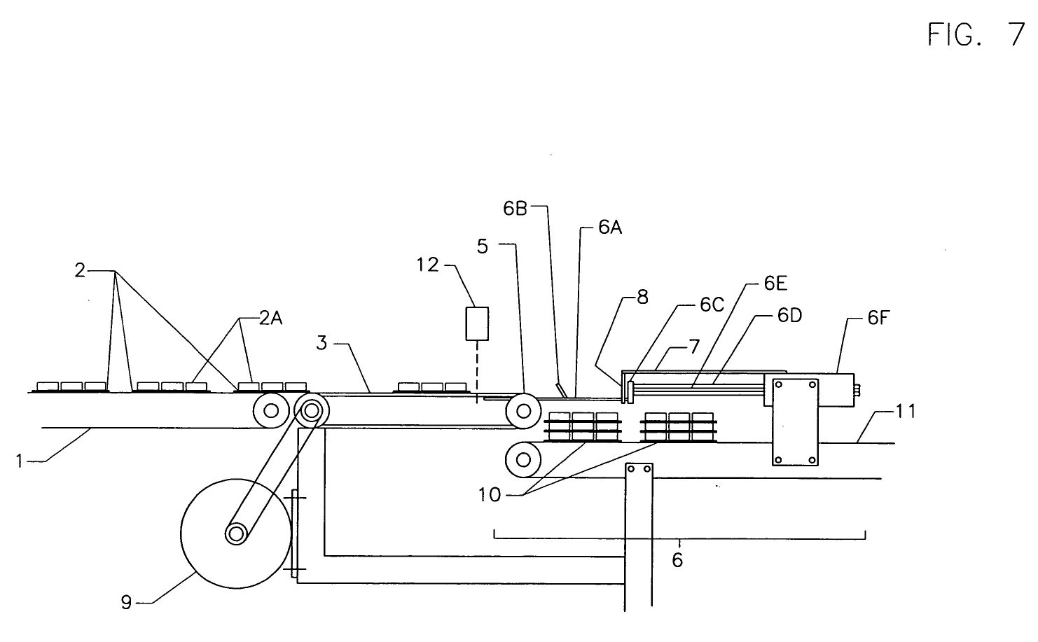

When linear motor 6F has retracted fingers 6A so that portion 2A and carrier sheet 2 are past the end and clear of rollers 5 of acceleration conveyor 3, linear motor 6F increases the rate of retraction of fingers 6A to a faster speed of approximately five or more times the initial retraction rate. During this accelerated retraction, as fingers 6A are withdrawn through separator bars 8 on support 7 (see FIG. 3A taken along section A-A′), portion 2A and carrier sheet 2 engage bars 8 which prevent portion 2A and carrier sheet 2 from moving further. Separator bars 8 are positioned to extend vertically between horizontal fingers 6A. FIG. 5 shows portion 2A and carrier sheet 2 just before engagement with separator bars 8. The rapid withdrawal of fingers 6A from underneath now stationary portion 2A and carrier sheet 2 causes portion 2A and carrier sheet 2 to drop under the influence of gravity onto stack 10 waiting on takeaway conveyor 11 as shown in FIG. 6 and FIG. 7. Since each successive portion 2A and carrier sheet 2 is brought to the same position against bars 8 before being dropped, a uniform stack 10 is formed on takeaway conveyor 11. Alternatively, rather than having the portions 2A and carrier sheets 2 stacked directly on conveyor 11, a suitable packaging structure such as a container with open top (not shown) may be positioned below the drop point into which the portion 2A on carrier 2 maybe stacked.

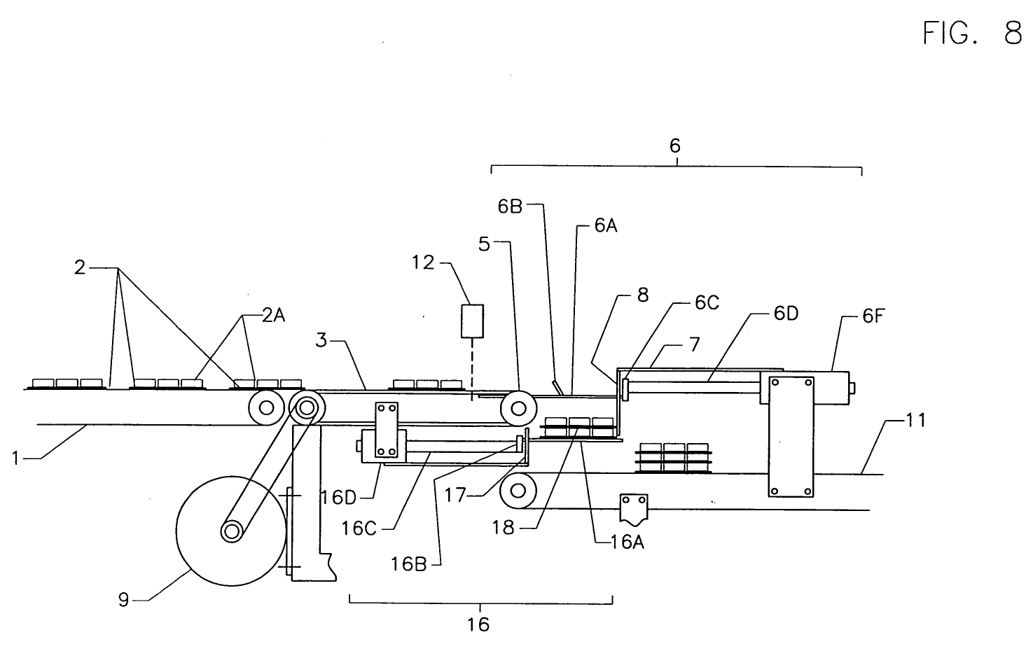

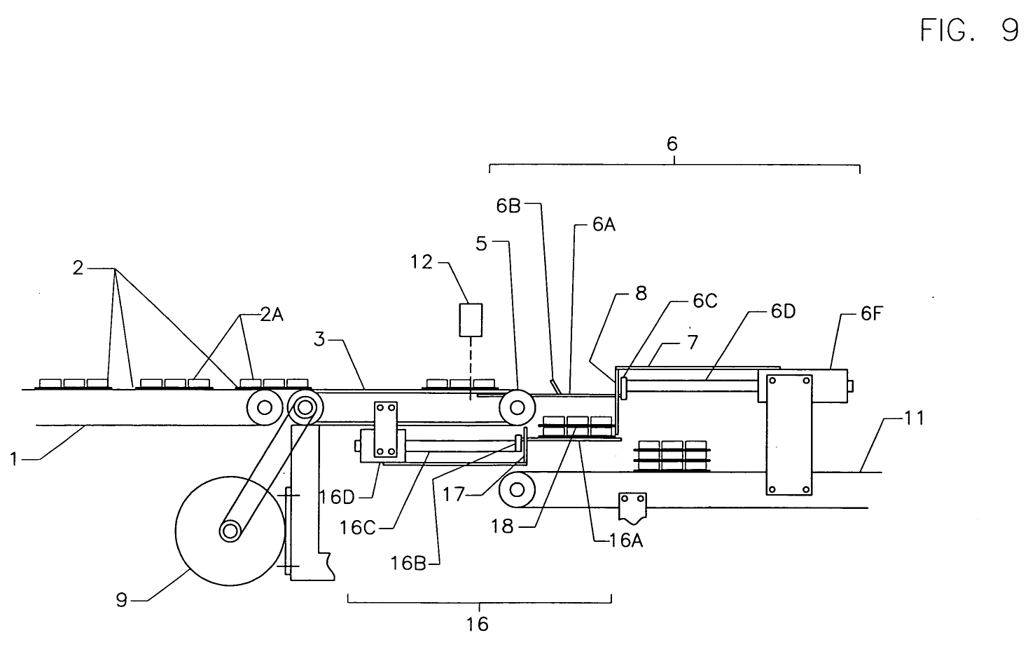

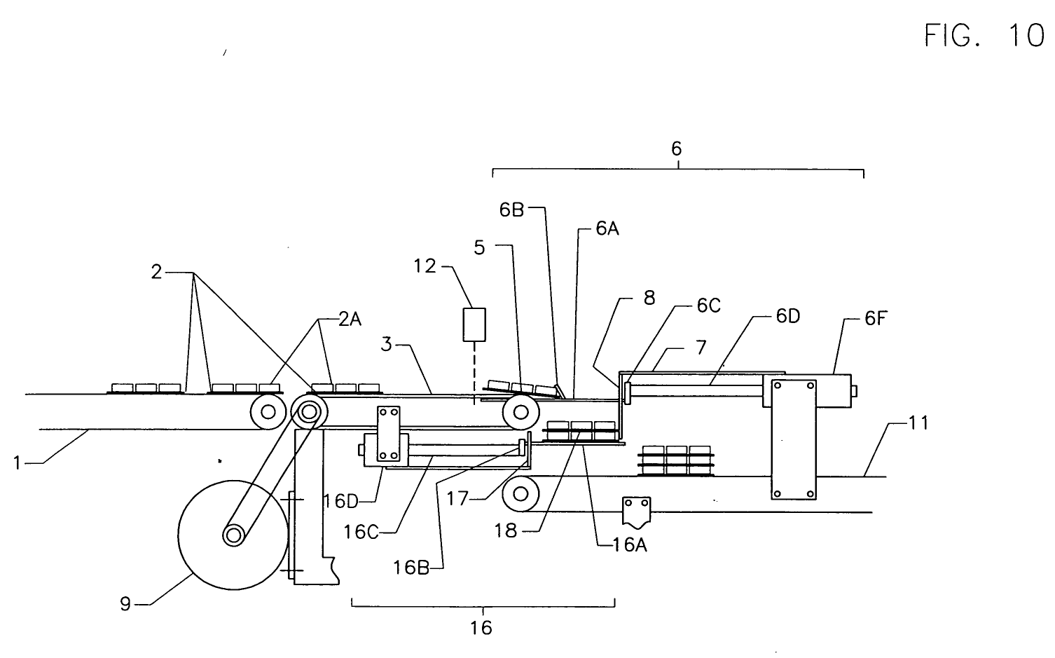

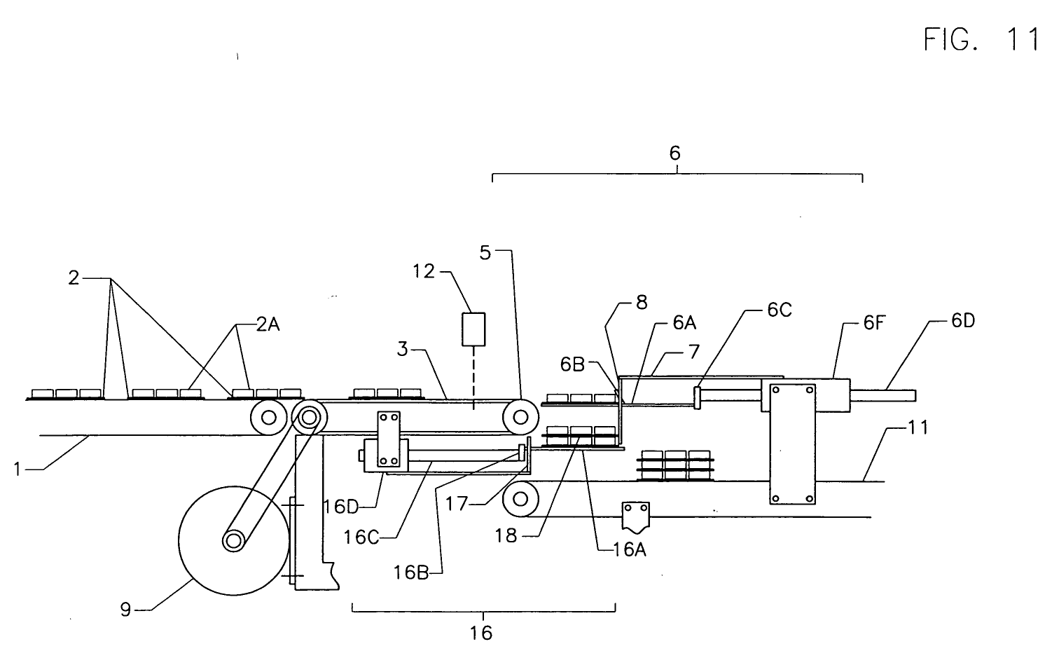

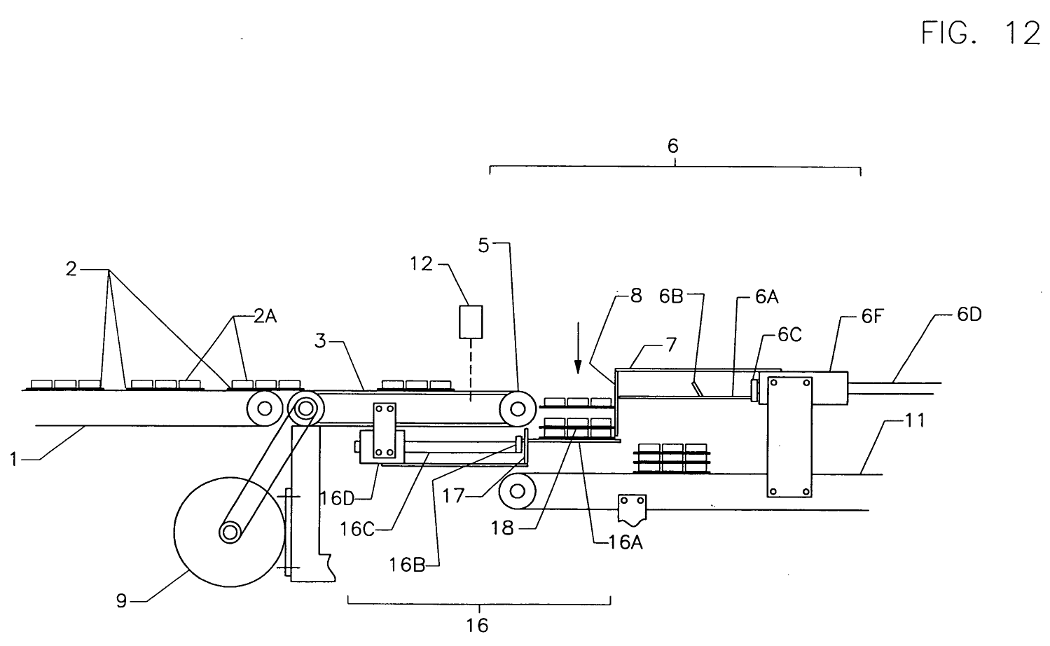

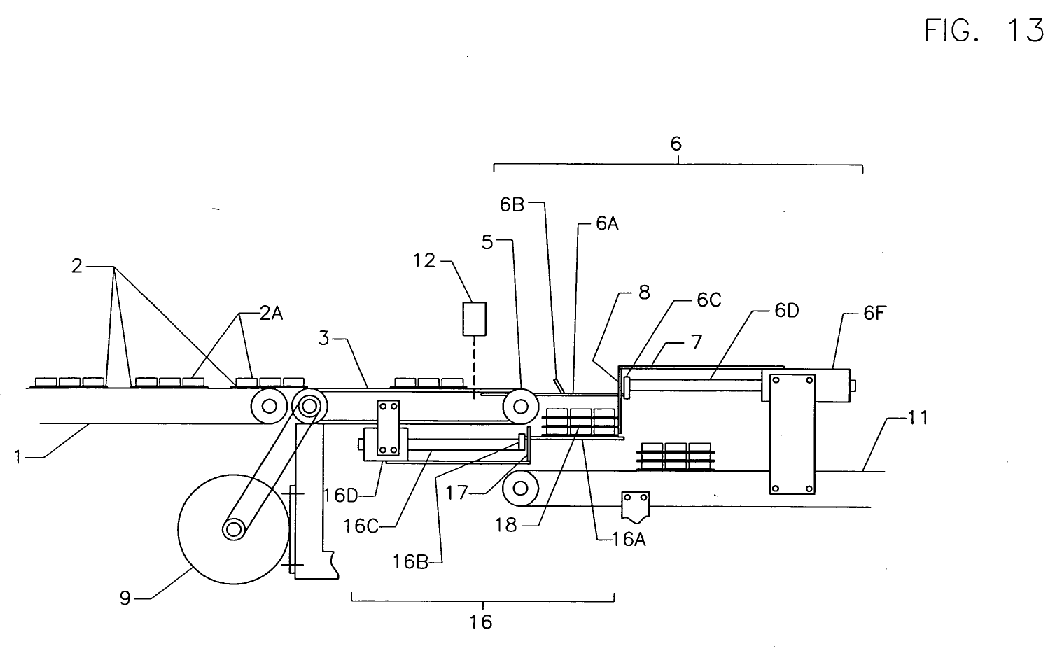

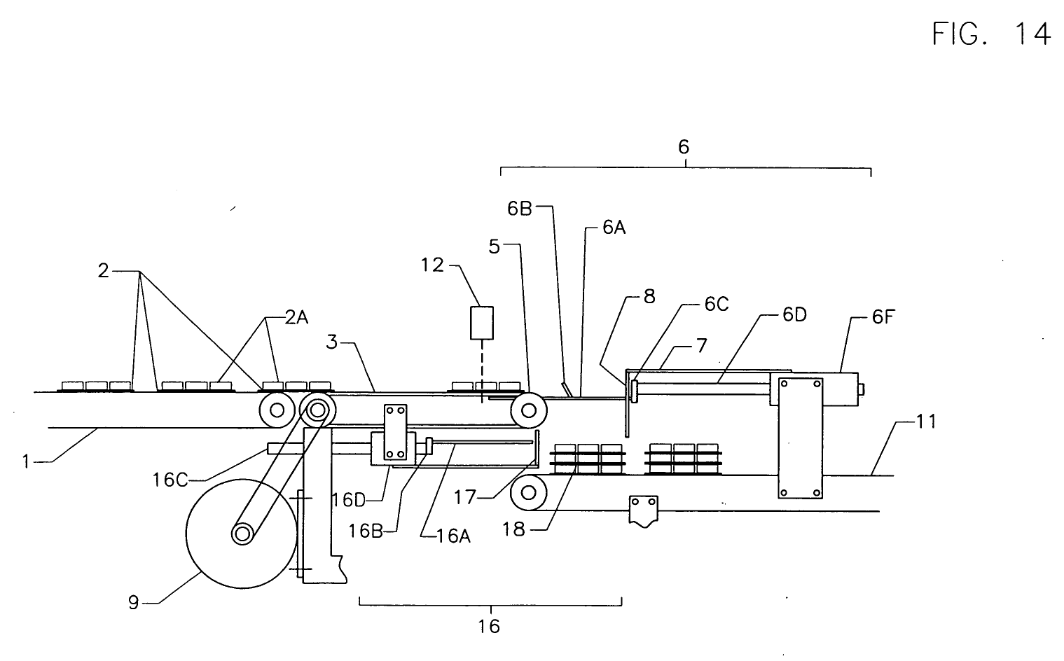

In cases where it is desirable to stack a higher volume of portions 2A and carrier sheets 2 per minute, an optional second horizontal slide platform assembly 16 may be located below the top first horizontal slide platform as shown in FIG. 8. In similar fashion to the top stacker assembly, the second horizontal slide platform assembly 16 consists of fingers 16A, mounting plate 16B, drive rod 16C, and linear motor 16D. Fingers 16A pass through separator plate bars 17. No stops are used on fingers 16A since portions 2A and carrier sheets 2 are already uniformly stacked by operation of the top slide platform stacker. The second lower horizontal slide platform assembly 16 is used to accumulate a specified number of portions 2A and carriers 2 in an intermediate stack 18 under the first top slide platform 6 before fingers 16A are withdrawn against separator bars 17 thereby dropping the entire stack to waiting takeaway conveyor 11. This allows the takeaway conveyor 11 more time to move slowly for packaging. More than two horizontal slide platform assemblies may be employed if necessary.

It is envisioned that this system will work with portions that may be provided without carrier sheets. It is further contemplated that the takeaway conveyor belt could be a solid flat belt or one with flighted raised cleats spaced to accommodate the portion size and sequenced by the completion of a stack count or by utilizing a belt with a weight controller.

While only portions of the support frames have been shown in the Figures, it is well understood by those skilled in the art that all the elements of the stacking system including the conveyors, conveyor motors, control systems, linear motors, and separator bars are mounted to one or more support frames which maintain the relative positions of the stacking elements with respect to each other.

We claim:

1. An apparatus for staking comestible portions on carrier sheets utilizing a horizontal linear slide platform stacker assembly comprising:
a. a mounting block;
b. protruding fingers to receive portions on carrier sheets fixedly attached to the mounting block;
c. sheet stops mounted on the fingers and angled toward the unmounted ends of the fingers;
d. a linear servo motor assembly fixedly attached to a frame;
e. horizontal linear slide support rods fixedly attached to the mounting block and slidably engaging the motor assembly;
f. a horizontal drive rod fixedly attached to the mounting block and slidably engaging the motor assembly; and
g. separator bars;
wherein the linear servo motor assembly drives the horizontal linear slide support to horizontally displace the mounting block.

2. A method of stacking comestible portions on carrier sheets comprising the steps of:
a. conveying by means of a conveyor the portions on the stack sheets towards a mounting block having fingers protruding in the direction of the conveyor;
b. sliding the stack sheets off the conveyor onto the protruding fingers on the mounting block;
c. decelerating the mounting block to retain the comestible portions on the fingers;
d. rapidly retracting the mounting block so that the stack sheets engage separator bars;
e. continuing the rapid retraction of the mounting block to withdraw the fingers supporting the stack sheets from under the stack sheets;
f. dropping the stack sheets onto a lower receiving conveyor; and
g. repeating steps a) through e) until the desired number of sheets have been stacked.
